(19) United States
(12) Patent Application Publication
(10) Pub. No.: US 2006/0090067 A1
(43) Pub. Date: Apr. 27, 2006

(54) Method and apparatus for performing a secure transaction in a trusted network

(76) Inventors: Philip G. Edmonds, Oxford (GB); David A. Robinson, Northants (GB); Claire Green, Oxford (GB); Michio Wise, Bucks (GB)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/244,204

(22) Filed: Oct. 5, 2005

(30) Foreign Application Priority Data
Oct. 6, 2004 (GB) 0422132.1

(51) Int. Cl. H04L 9/00

(52) U.S. Cl. 713/159

(57) ABSTRACT

A method is provided of enabling respective users (A, B) of first and second devices (12, 2) of a trusted network to perform a secure transaction between them. A communications channel, such as a telephone conversation, is established between the users (A, B). A verification identifier for the transaction is communicated between the users (A, B) using the communications channel (A6). The verification identifier is stored (A3) at the first device (12) as a reference identifier for the transaction. A secure connection is opened between the two devices (12, 2) over the trusted network (A10), the secure connection being different to the communications channel between the users (A, B). The verification identifier is sent (A11) from the second device (2) to the first device (12) over the secure connection. The verification identifier received over the secure connection is compared (A12) with the reference identifier at the first device (12). The secure transaction is performed over the secure connection (A15) in dependence upon the comparison.

### BACKGROUND OF THE INVENTION

1. Field of the Invention

The present invention relates to a method and system for enabling respective users of first and second devices of a trusted network to perform a secure transaction between them. In particular, the present invention provides a convenient and secure method for two individuals to initiate a secure transaction, such as adding a new individual to a secure network or group.

2. Description of the Related Art

Social networks are a fundamental part of people's lives. With modern technologies, such as the phone and the Internet, forming and maintaining one's social networks has been facilitated by the large range of people and activities that are now effortlessly accessible, combined with always-on instant communication. However, this has also led to difficulties because of the increased complexity of managing one's many different networks and of ensuring sufficient privacy and security when necessary.

It is now common for small groups of people to form ad hoc groups, especially on the Web using email, chat rooms, community sites, peer-to-peer (P2P) systems, and other software, and on mobile phones through messaging and Internet services. Such groups can range from single ephemeral transactions, to longer persistent sessions, to lifelong groups with a changing roster of members. These can all be managed with very little central administration, and in the case of email and P2P, no central administration. However, providing security and privacy is not a strong point of such systems, because it is (in part) often too difficult for untrained users to understand and use current security infrastructure. Secure systems often require users to have pre-established electronic identities on a variety of security infrastructures.

At the same time, there are more and more devices that connect to the Internet but do not have the standard software configuration required of the above group-forming systems. Devices such as televisions, digital set-top boxes, and personal multimedia players might not have Web browsers, email clients, and clients to access security and addressing infrastructure.

A computer network is a group of computers, devices, or computational nodes interconnected by communication paths. A computer network can generally carry any kind of data and support a variety of applications. One application is a virtual network within a computer network that interconnects a subset of the nodes and uses the facilities of the real network to transport data between the nodes. A virtual network can be made secure with respect to the real ‘public’ network by, for example, encrypting any data that is sent over the network using a shared secret key that is known only to the participants of the network. Individuals outside of such a network could not decrypt the data, and thus could not gain access to the virtual network.

Network security addresses several concerns including privacy/confidentiality, integrity, and authentication. Privacy or confidentiality means that information cannot be seen in transit by unauthorized parties. Integrity means that information cannot be modified in transit by unauthorized parties. Authentication is the act of verifying that an individual is who they say they are (in particular, of verifying that an electronic identity is being used by the person to whom it was issued).

Broadly speaking, there are two basic types of cryptographic system for networks, symmetric and asymmetric, which both rely on keys (there are of course many composite systems). A central problem in cryptographic systems is how to initiate or set up a secure network. For example, the secret key (above) needs to be exchanged securely before the secure network itself is established. There are two aspects to the key exchange or key distribution problem: the key itself needs to be exchanged (sometimes securely) and the individuals that exchange the key must authenticate each other.

Key exchange in symmetric cryptography requires an out-of-band transaction such as word-of-mouth (e.g., over the phone, or physical meeting), physical transfer (e.g., floppy disk), mail, email, or any other delivery method that uses a different channel (communication path) than the ultimate encrypted channel, and which is not susceptible to eavesdropping. In most cases, the simplicity and convenience of the method is inversely related to its confidentiality and reliability of authentication. The most secure and reliable method requires a physical meeting, which might be acceptable for, say, joining a corporate VPN (Virtual Private Network), but inconvenient or impossible for joining a secure chat room on the Internet. Email is convenient but insecure. Strong keys can also be very long (at least 128 bits), and might have to be exchanged several times (e.g., to switch to a new key when a group member leaves), so phone calls are also unacceptable, even though the call itself is convenient. Symmetric key exchange is thus unsuitable for small ad hoc groups.

Symmetric key exchange can also be done using an asymmetric system to first establish a secure channel. In an asymmetric system, information encrypted by one key of a pair can be decrypted only by the other key. Thus, one individual can send a secret to a second individual by encrypting it with the second individual's ‘public’ key, which can then be decrypted only by the second individual's ‘private’ key. If the second individual has kept the key private then only the second individual can gain access to the secret.

The above is just one example of an asymmetric system; many other configurations are possible. The main difficulty in all of them lies in key distribution, which comes down to authentication. In the above example, the first individual must make sure that the public key belongs to the second individual and not someone else masquerading as the second individual. Many complex systems have evolved to solve the authentication problem. In brief, Public. Key Infrastructure (PKI) relies on a trusted third party, called a central authority, to sign public keys and issue public key certificates. Secure Sockets Layer (IETF Internet-draft “The SSL Protocol Version 3.0”) and Transport Layer Security (IETF RFC 2246, “The TLS Protocol Version 1.0”) use PKI to secure transactions over the Internet. In Pretty Good Privacy (PGP Corporation), trust is built up through a network of relationships with other individuals, in which the individuals sign each other's keys (e.g., if A trusts B, and B trusts C, then A might trust C). The details of these systems are beyond the scope of this disclosure.

PKI is not suitable, on its own, for small ad hoc groups, because it requires a trusted central authority. Every individual must acquire a public key certificate issued from a third party, which, to maintain a trustworthy reputation, must carefully vet every application. Even if a small-group owner were to create his own certificate authority, he would need a higher certificate authority to guarantee his identity and trustworthiness. This involves a substantial amount of communication between users to establish public key certificates. PGP is also unsuitable for small groups, despite its apparent appeal, because the initial relations of trust (i.e., signing other people's keys) must be built up through (trustworthy) face-to-face meetings or through trusted email, which requires additional infrastructure.

While PKI and PGP on their own may be unsuitable, there are ways to combine them with out-of-band communication to the service of small ad hoc groups. P2P architectures for ad hoc groups are designed to avoid the need for a centralized infrastructure. There are several solutions for P2P security in the prior art, but they all either rely on software or infrastructure that might not be available to a client device or user, or are not simple and convenient to use.

Groove Workspace is a P2P online collaboration tool (Udell, Asthagiri, Tuvell. 2001. Security. In Oram, editor, “Peer-to-Peer: Harnessing the Power of Disruptive Technologies”.). To form a new group, the group owner creates the group and directly invites the group members. A group invitation can either be sent by means of the Groove system, if the invitee has installed the software, or by means of email, if not. In both cases, the invitation contains the owner's electronic identity and public key signed by the owner's private key. The invitee must then authenticate the owner. This can be done by means of a PKI or by phoning the group owner and comparing the invitee's ‘fingerprint’ of the owner's public key to the owner's fingerprint. A fingerprint is a short hash (string of hex digits) of the public key. In this scenario, the invitee uses the out-of-band phone call to authenticate the group owner by his voice. To complete the invitation, the invitee instructs her software to reply to the invitation; the reply is a reciprocal to the invitation from which the owner can authenticate the invitee using the same fingerprint/phone technique. Clearly, this combination of email and voice phone call is complex for the users and requires email infrastructure.

In U.S. Patent Application 2003/0056093, an owner or group member creates an invitation by encrypting the invitee's public key using the group's private key (called the invitee's group certificate). The invitation is sent by email or other electronic delivery system. The invitee then responds to the invitation by sending a connect message signed by her private key. The owner can then verify that the invitee is the one invited in the invitation. The owner accepts the connection by responding with his group certificate encrypted by his private key. Finally, the invitee can verify the owner's identity from the acceptance message. This scenario has two problems: 1) the owner must get the invitee's public key, and 2) true authentication of the owner and invitee is not achieved. To resolve the former, the public key can be obtained through prior contact, through a directory service, or through email (or other messaging system.). The public key could be encrypted by a short symmetric pass-phrase which can be communicated out-of-band by phone call. The latter problem can be resolved by using any authentication method, including methods such as the above pass-phrase and phone call, or a PKI. In summary, for full security a pre-established security infrastructure is required in addition to email and phone calls.

U.S. Patent Application 2003/0070070 proposes a general P2P architecture in which trust (for authentication) is derived through 1) a range of different PKIs (using a group certification authority, or a real third party certificate authority), 2) through a PGP-like mechanism, or 3) through the physical exchange of certificates by, for example, floppy disk. In all cases, the architecture relies on the user taking part in an pre-established security infrastructure, or through physical contact.

Still other systems use a centralized architecture for group formation, and then switch to a P2P architecture for group activity. U.S. Patent Application 2004/0006708 describes a method for forming a P2P VPN in which a group owner registers on a central server a list of members who may join the group. The service creates an identifier for the group. When a member requests to join the group (using the group identifier, which he has received through some means from the owner), his authorization is verified, and a virtual host is created for him on the server. A tunnel (a secure channel) is established between him and the host. All secure communications are done through the tunnels, which interconnect within the central server. U.S. Patent Application 2004/0044891 describes a similar method, except that the central server distributes shared group keys to the group members. The group members use the keys to encrypt group traffic, which is sent directly between group members. Both of these methods rely on an inconvenient pre-registration of all group members, and it is not clear how authentication occurs.

Accordingly, there exists a need for a method that provides a simple and convenient formation and configuration of small secure ad hoc groups within a public network that does not require either standard software in client devices or the user to participate in a pre-established security/addressing infrastructure.

### SUMMARY OF THE INVENTION

According to a first aspect of the present invention, there is provided a method of enabling respective users of first and second devices of a trusted network to perform a secure transaction between them, comprising: establishing a communications channel between the users; communicating a verification identifier for the transaction between the users using the communications channel; storing the verification identifier at the first device as a reference identifier for the transaction; opening a secure connection between the two devices over the trusted network, the secure connection being different to the communications channel between the users; sending the verification identifier from the second device to the first device over the secure connection; comparing the verification identifier received over the secure connection with the reference identifier at the first device; and performing the secure transaction over the secure connection in dependence upon the comparison.

The method may comprise performing the secure transaction only if the comparison indicates a match between the verification and reference identifiers.

The method may comprise closing the secure connection if the comparison does not indicate a match between the verification and reference identifiers.

The method may further comprise: communicating a first device identifier, identifying the first device in the network, from the first user to the second user; and using the first device identifier at the second device to open the secure connection.

The first device identifier may be communicated using the communications channel between the users.

The verification identifier may be communicated from the first user to the second user using the communications channel, and further comprise inputting the verification identifier into the second device for use in the sending step. The method may further comprise generating the verification identifier at the first device. The first device identifier may be used as the verification identifier.

The method may comprise communicating a single transaction code from the first user to the second user comprising the first device identifier and the verification identifier. The transaction code may be formed by appending the first device identifier to the verification identifier.

The verification identifier may be communicated from the second user to the first user using the communications channel, and further comprise inputting the verification identifier into the first device for use in the storing step. The method may further comprise generating the verification identifier at the second device. A second device identifier, identifying the second device in the network, may be used as the verification identifier.

The method may comprise generating a random number for use as the verification identifier.

The communications channel is preferably a communications channel that is trusted by the first and second users.

The communications channel may comprise one or more of: a telephone call between the users; physical contact between the users; direct voice communication between the users; transfer of a device-readable storage device between the users; email; and Short Message Service.

The method may further comprise revoking the reference identifier after a predetermined period of time.

The method may further comprise revoking the reference identifier after first use.

At least one of the first and second devices may be a multi-user device.

At least one of the identifiers may comprise one or more of: a number; a string; a name; an IP address; and a domain name.

The method may further comprise indicating the verification identifier for use in the communicating step to one of the users using that user's device. The method may further comprise displaying the verification identifier on a screen of the user's device.

The method may further comprise inputting the verification identifier received by one of the users in the communicating step into that user's device. The method may further comprise inputting the verification identifier using a keypad of the user's device.

The verification identifier preferably uniquely identifies the transaction.

The network may be a peer-to-peer network of devices. In a peer-to-peer network the devices are substantially equal in terms of functionality, in contrast with a client/server type of network, for example.

The method may further comprise: communicating a further verification identifier for the transaction between the users using the same or a different such communications channel; storing the further verification identifier at the second device as a further reference identifier for the transaction; sending the further verification identifier from the first device to the second device over the secure connection; comparing the further verification identifier received over the secure connection with the further reference identifier at the second device; and performing the secure transaction over the secure connection in dependence upon the comparison.

According to a second aspect of the present invention, there is provided a method of maintaining a group, comprising a plurality of members, using a method according to the first aspect of the present invention, wherein the step of performing a secure transaction relates to the addition or removal of one of the first and second users as a member of the group, the other of the first and second users being a designated coordinator for the group.

According to a third aspect of the present invention, there is provided a method of configuring a trusted network, comprising a method according to the first aspect of the present invention.

According to a fourth aspect of the present invention, there is provided a method for use by a first device of a trusted network for enabling a user of the first device to perform a secure transaction with a user of a second device of the trusted network, comprising: indicating a verification identifier for the transaction to the user of the first device for communication to the user of the second device using a communications channel established between the users, or inputting a verification identifier for the transaction communicated to the user of the first device from the user of the second device using a communications channel established between the users; storing the verification identifier as a reference identifier for the transaction; opening a secure connection between the two devices over the trusted network, the secure connection being different to the communications channel between the users; receiving the verification identifier from the second device over the secure connection; comparing the verification identifier received over the secure connection with the reference identifier; and performing the secure transaction over the secure connection in dependence upon the comparison.

According to a fifth aspect of the present invention, there is provided a method for use by a second device of a trusted network for enabling a user of the second device to perform a secure transaction with a user of a first device of the trusted network, comprising: indicating a verification identifier for the transaction to the user of the second device for communication to the user of the first device using a communications channel established between the users, or inputting a verification identifier for the transaction communicated to the user of the second device from the user of the first device using a communications channel established between the users, the verification identifier being stored at the first device as a reference identifier for the transaction; opening a secure connection between the two devices over the trusted network, the secure connection being different to the communications channel between the users; sending the verification identifier to the first device over the secure connection for use by the first device in comparing with the reference identifier; and performing the secure transaction over the secure connection in dependence upon the comparison.

According to a sixth aspect of the present invention, there is provided a system for enabling respective users of first and second devices of a trusted network to perform a secure transaction between them, comprising: means for establishing a communications channel between the users; means for communicating a verification identifier for the transaction between the users using the communications channel; means for storing the verification identifier at the first device as a reference identifier for the transaction; means for opening a secure connection between the two devices over the trusted network, the secure connection being different to the communications channel between the users; means for sending the verification identifier from the second device to the first device over the secure connection; means for comparing the verification identifier received over the secure connection with the reference identifier at the first device; and means for performing the secure transaction over the secure connection in dependence upon the comparison.

According to a seventh aspect of the present invention, there is provided a device for use in a trusted network for enabling a user of the device to perform a secure transaction with a user of another device of the trusted network, comprising: means for indicating a verification identifier for the transaction to the user of the device for communication to the user of the other device using a communications channel established between the users, or inputting a verification identifier for the transaction communicated to the user of the device from the user of the other device using a communications channel established between the users; means for storing the verification identifier as a reference identifier for the transaction; means for opening a secure connection between the two devices over the trusted network, the secure connection being different to the communications channel between the users; means for receiving the verification identifier from the other device over the secure connection; means for comparing the verification identifier received over the secure connection with the reference identifier; and means for performing the secure transaction over the secure connection in dependence upon the comparison.

According to an eighth aspect of the present invention, there is provided a device for use in a trusted network for enabling a user of the device to perform a secure transaction with a user of another device of the trusted network, comprising: means for indicating a verification identifier for the transaction to the user of the device for communication to the user of the other device using a communications channel established between the users, or inputting a verification identifier for the transaction communicated to the user of the device from the user of the other device using a communications channel established between the users, the verification identifier being stored at the other device as a reference identifier for the transaction; means for opening a secure connection between the two devices over the trusted network, the secure connection being different to the communications channel between the users; means for sending the verification identifier to the other device over the secure connection for use by the other device in comparing with the reference identifier; and means for performing the secure transaction over the secure connection in dependence upon the comparison.

According to a ninth aspect of the present invention, there is provided an operating program which, when loaded into a device, causes the device to become a device according to the seventh or eighth aspects of the present invention.

According to a tenth aspect of the present invention, there is provided an operating program which, when run on a device, causes the device to carry out a method according to the fourth or fifth aspects of the present invention.

The operating program may be carried on a carrier medium. The carrier medium may be a transmission medium. The carrier medium may be a storage medium.

With an embodiment of the present invention, users have the ability to initiate a secure transaction between network devices, which in turn enables them to form a secure group, without the need for approval from a third party, or the need for substantial resources of a third party. It is straightforward and convenient for users to initiate the transaction, providing an optimal user experience. Users do not have to participate in any pre-established addressing (for example, email correspondence) and do not require a security infrastructure. The process is secure, involving confidentiality, integrity, and authentication, and this allows multi-user network devices to be used securely in an embodiment of the present invention. A user is able to use any type of network device that has sufficient computational power and user interface.

### BRIEF DESCRIPTION OF THE DRAWINGS

FIG. 1 illustrates a trusted device network forming the basis of an embodiment of the present invention;

FIG. 2 is a message exchange diagram showing the sequence of messages passed between a new user, a group owner, and their respective devices, in a first embodiment of the present invention;

FIG. 3 is a flowchart providing an alternative view of the procedures shown in FIG. 2, showing some of the processing performed by the new user's device and the owner's device;

FIG. 4 is a schematic diagram illustrating the interactions between the various parties and devices in the first embodiment;

FIG. 5 is a message exchange diagram showing the sequence of messages passed between a new user, a group owner, and their respective devices, in a second embodiment of the present invention;

FIG. 6 is a flowchart providing an alternative view of the procedures shown in FIG. 5, showing some of the processing performed by the new user's device and the owner's device;

FIG. 7 is a schematic diagram illustrating the interactions between the various parties and devices in the second embodiment;

FIG. 8 is a message exchange diagram showing the sequence of messages passed between a new user, a group owner, and their respective devices, in a third embodiment of the present invention;

FIG. 9 is a flowchart providing an alternative view of the procedures shown in FIG. 8, showing some of the processing performed by the new user's device and the owner's device; and

FIG. 10 is a schematic diagram illustrating the interactions between the various parties and devices in the third embodiment.

### DETAILED DESCRIPTION OF THE PREFERRED EMBODIMENTS

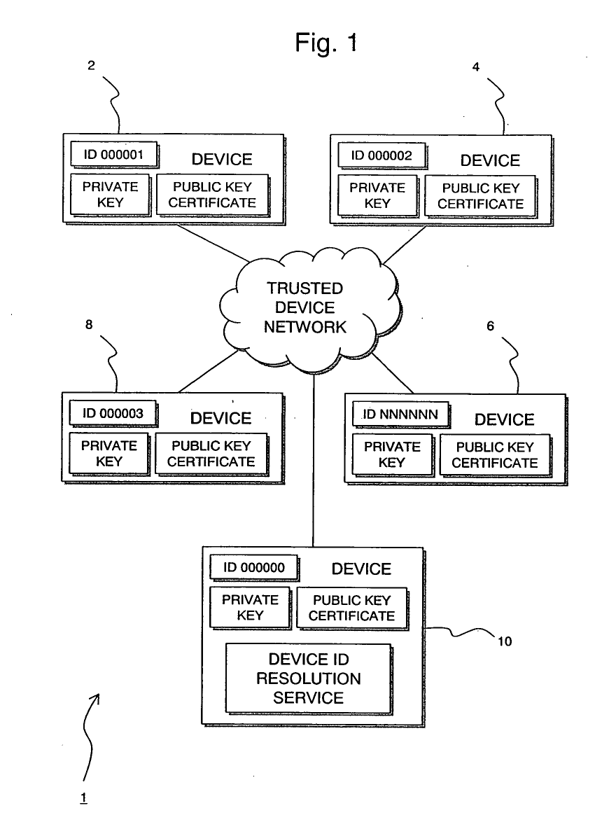

FIG. 1 illustrates a trusted device network 1 comprising four network devices 2, 4, 6 and 8 and an identifier-resolution service 10. An embodiment of the present invention is based on such a pre-established trusted network 1 of devices. A network is considered trusted in this context if any device can send a message to any other device with complete security (confidentiality, integrity, and authentication), at least up to a predetermined security level. A trusted network implies that the devices and/or users are able to trust the level of security that it provides. It should be noted that a trusted device network forming the basis of an embodiment of the present invention is different from the security and addressing infrastructures discussed above, which involve securing communications between people.

The devices 2, 4, 6 and 8 in the trusted network 1 each have a unique identifier (ID). The identifier can be a number, a name, an IP address on the Internet, a domain name, or any other string, so long as it is unique within the trusted network. A trusted network of devices can be set up by a device manufacturer without the users' intervention. The purpose of the device-identifier resolution service 10 is to resolve unique device identifiers to real addresses in the trusted network 1, as described further below; any means of resolving the identifier to a real address is permitted.

The manner of establishing the network is not important, but one way in which a trusted network of devices can be set up is as follows. Each device manufactured is assigned a unique identifier consisting of a string of digits. For example, if it is expected to manufacturer 1,000,000 devices, then six-digit identifiers would suffice. This identifier is considered the electronic identity of the device for the purposes of a PKI. A public/private key pair is generated for each device. The private key is stored within the device. The public key and device identifier is signed by a certificate authority (which could be operated by the manufacturer or a third party). The resulting public key certificate is also stored in the device. The public key certificate of the certificate authority (perhaps signed by a higher certificate authority, such as Verisign), is stored in each device. In this example, the device should be tamper resistant. For example, all of the above keys and identifiers, in addition to cryptographic software, can be stored in a Smart Chip on the device in order to eliminate the potential for tampering with the device or the trusted device network.

Each device is given the capability to connect to a public network. For example, if the Internet is the target network, then each device is given the capability to use TCP/IP (Transmission Control Protocol/Internet Protocol, the set of protocols that govern the Internet). To enable the trusted network, each device is also given the capability to employ SSL (Secure Sockets Layer, a protocol layer over TCP). Devices can now open completely secure connections between one another using SSL with two-way authentication. SSL assures confidentiality, integrity, and authentication.

A mechanism is also required to resolve device identifiers to IP addresses. A device's IP address might change over time, but the device identifier remains constant. The actual means of identifier resolution is not important. For example, in the illustrated network 1 of FIG. 1, a central identifier-resolution service 10 is used to convert device identifiers into IP addresses. Alternatively, a P2P resolution scheme could be used in which other devices in the trusted network provide a distributed resolution service.

A resolution service 10 could be provided by the device manufacturer or a third party, with the service operating as follows, for example. When a new device connects to the network, or when a device's IP address changes, the device connects to the resolution service (over the trusted device network; the service runs in a trusted device) and notifies the resolution service of its identifier and current IP address. The service stores this information in a table. When a second device requires the IP address of the first device given the first device's identifier, it connects to the resolution service and requests the IP address of the first device's identifier. The service consults its table and returns the IP address stored therein. This information can then be stored (cached) in the second device, alleviating the need to continually connect to the resolution service.

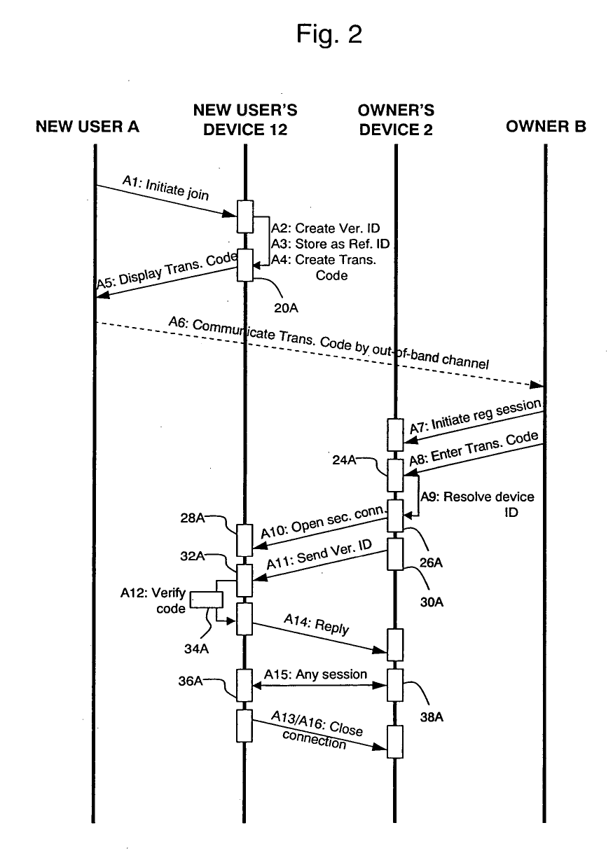

An embodiment of the present invention provides a method for initiating a secure transaction using such a secure network as described above. The embodiments to be described below with reference to FIGS. 2 to 10 are set in a context where the secure transaction is one that allows the formation and administration of a group of members or users (for example, adding a new member to the group), but it is to be understood that the type of secure transaction that is initiated is not intended to be limited to this.

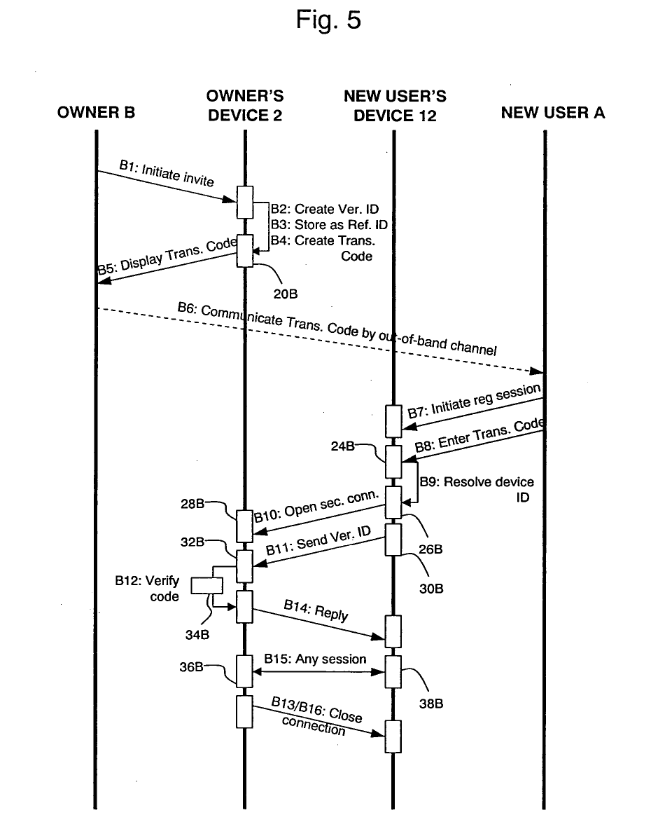

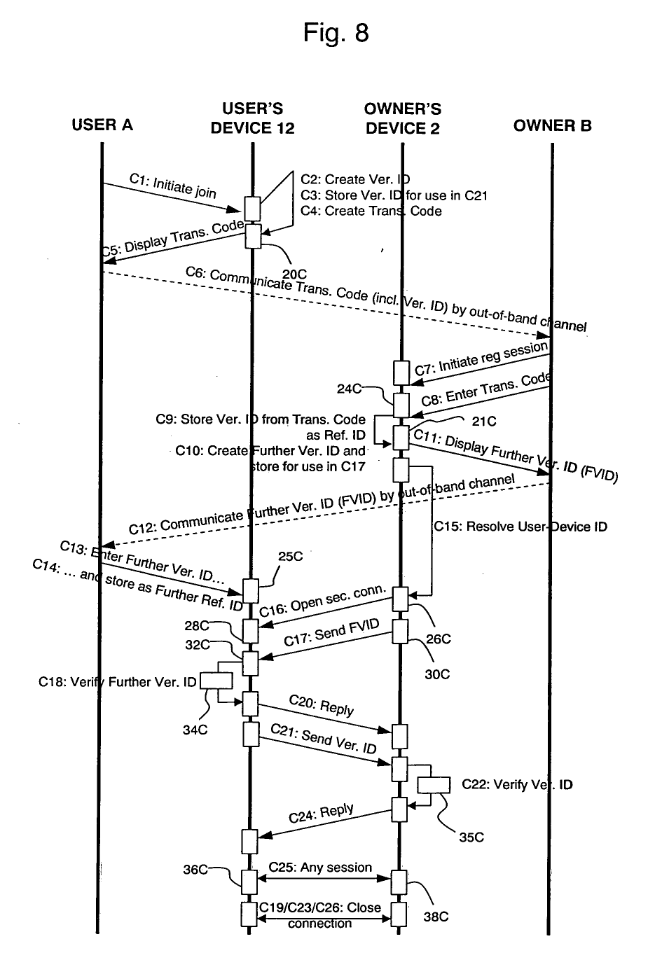

Three particular embodiments of the present invention will be described. The first embodiment will be described with reference to FIGS. 2 to 4, the second embodiment will be described with reference to FIGS. 5 to 7, and the third embodiment will be described with reference to FIGS. 8 to 10.

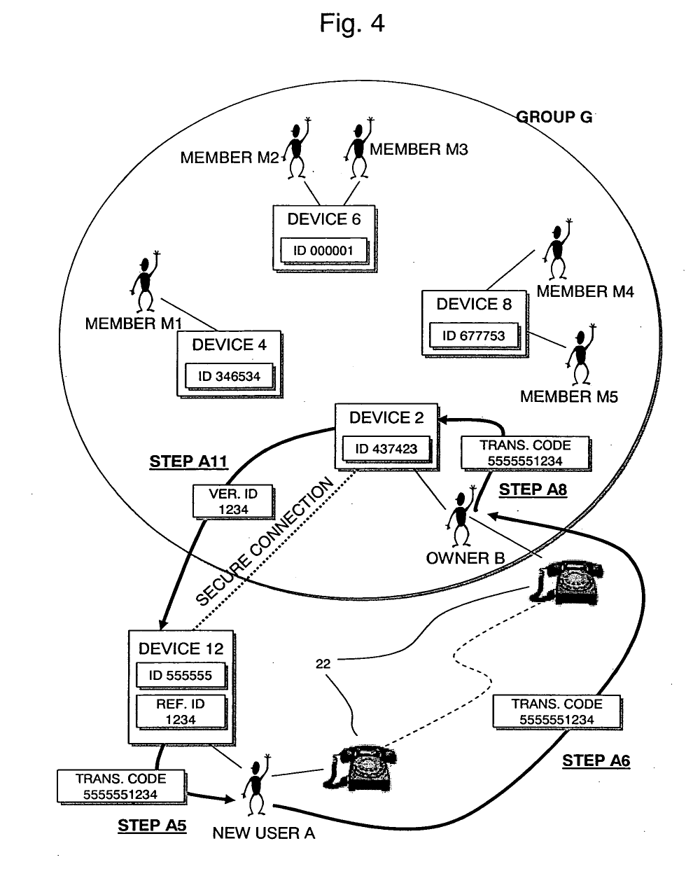

In each of the first to third embodiments, an existing group G (see FIGS. 4, 7 and 10) comprises five members M1 to M5, with member M1 using device 4, members M2 and M3 using device 6 and members M4 and M5 using device 8. One person is designated as the group owner B, with the group owner B using device 2. In each embodiment, a situation is described in which a new user A, using device 12, is joining the group G, and a secure transaction is in each case performed between devices 2 and 12 to enable the new user A to join the group G. The secure transaction is initiated after an exchange of information between the relevant parties and devices as described below.

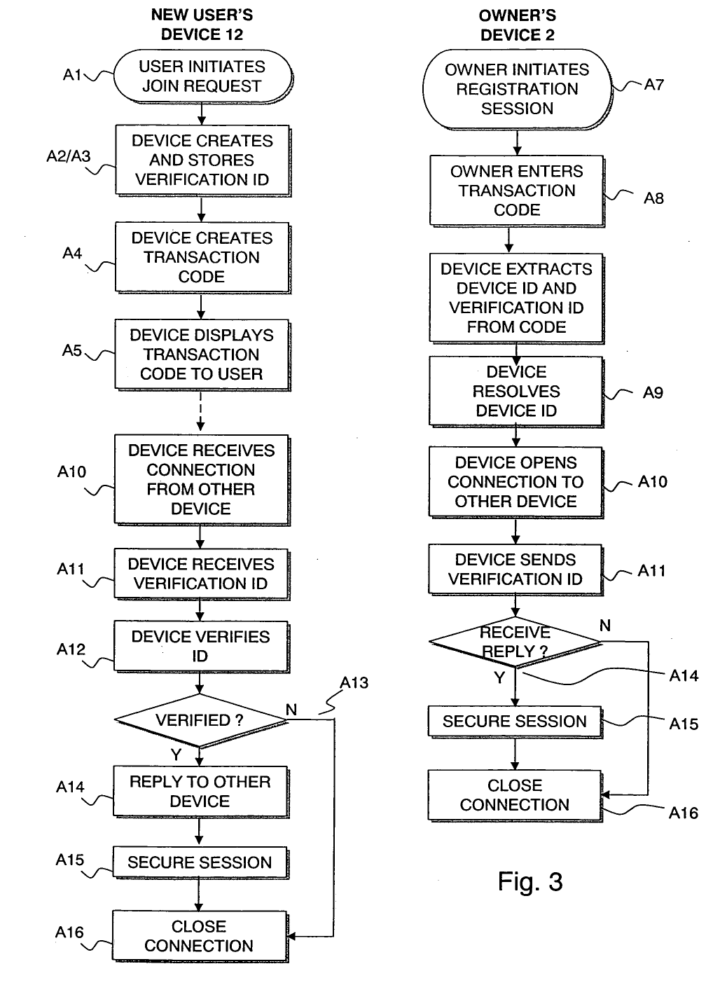

The first embodiment will now be described with reference to FIGS. 2 to 4. In the first embodiment, the new user A initiates the group registration or join procedure. FIG. 2 is a message exchange diagram showing the sequence of messages that pass between new user A, owner B, and their respective devices 12 and 2. FIG. 3 is a flowchart providing an alternative view of the procedures shown in FIG. 2, showing the flow of processing specifically for the new user's device 12 and the owner's device 2. FIG. 4 is a schematic diagram illustrating the various parties and devices and how they interact. Like reference numerals refer to like parts or method steps.

In step A1, the new user A initiates a join request on the user's device 12. The device 12 requests user A to log in using the user's username and a password, or to create a new username and password, with a username table being stored locally in the device 12. The username is associated with a user identifier that identifies the user within the group, according to a predetermined group formation policy.

In step A2, user A's device 12 generates a verification identifier. In this embodiment the verification identifier is a four-digit random number, which in the schematic example shown in FIG. 4 is the number “1234”.

In step A3, the verification identifier “1234” is stored in user A's device 12 as a reference identifier “1234” for later use. The reference identifier “1234” is associated with the username and stored in a table in the device 12. A timestamp is also associated with the reference identifier “1234” and stored in the table.

In step A4, user A's device 12 creates a transaction code comprising user A's device identifier “555555” and the verification identifier “1234”. In this embodiment, the transaction code is created by appending the verification identifier “1234” to the device identifier “555555”, resulting in a ten-digit transaction code “5555551234”.

In step A5, an indication portion 20A of user A's device 12 operates to communicate or indicate the transaction code “5555551234” to user A, for example using a display, together with a suitable message to instruct user A to call the owner B of the group G to which user A wishes to join, and to communicate the transaction code “5555551234” to the owner B in this way.

In step A6, user A communicates the transaction code “5555551234” to the owner B using a voice phone call as the communications channel 22, and also indicates which group he wishes to join should the owner administer more than one group.

In step A7, the group owner B, having received the transaction code “5555551234”, initiates on his device 2 a registration session. If he owns more than one group, he selects the group previously agreed with the new user A. The device 2 requests the owner B for his username and password to ensure that he is the authorized owner.

In step A8, the owner B enters the transaction code into the device 2 using an inputting portion 24A. In this embodiment, a numeric keypad is used as the inputting portion 24A.

In step A9, owner B's device 2 extracts the device identifier “555555” and the verification identifier “1234” from the transaction code “5555551234”. The device 2 consults the aforementioned resolution service 10 to resolve the identifier “555555” to the IP address of the user A's device 12.

In step A10, owner B's device uses a portion 26A to open a secure connection to the user A's device 12 via portion 28A of device 12 using SSL with two-way authentication. The devices 2 and 12 authenticate each other using their public key certificates and the public key certificate of the certificate authority. Should either authentication fail, the connection is closed and the registration session aborted.

In step A11, owner B's device 2 uses portion 30A to send the verification identifier “1234” to the user's device over the secure connection, in the first step of a predetermined registration protocol. In one such registration protocol the message can have the form “invite <verification identifier>”. The verification identifier “1234” is received by user A's device 12 over the secure connection using portion 32A.

In step A12, user A's device 12 consults a stored table of reference identifiers, including the stored reference identifier “1234” in this example, and uses comparison portion 34A to compare the received verification identifier “1234” with each of the stored reference identifiers. It verifies a match between the received verification identifier “1234” and one of the stored reference identifiers “1234”. It also verifies that the time elapsed from the timestamp previously stored in the table is less than an expiration threshold, beyond which expiration threshold the reference identifier is revoked.

In step A13, a determination is made as to whether both these requirements are met, and based on this determination subsequent steps A14 and A15 are either carried out or not.

If verification is unsuccessful, the user A's device 12 closes the connection according to step A16, aborting the registration session. In any case, the reference identifier “1234” is deleted so that it cannot be used again.

If both verifications are successful, processing continues to step A14, in which user A's device 12 replies to owner B's device 2, as the second step of the predetermined registration protocol, to indicate that it accepts the registration. In one such registration protocol the message can have the form “accepted”.

In step A15, the two devices 12 and 2 use respective portions 36A and 38A to perform a secure transaction using a protocol defined within the group formation policy in order to join the new user to a group. The particular group-join session used is not important and will depend on the particular policy adopted. In one such example, user A's device 12 sends a user identifier (and possibly username and other user-specific information, for which refer to step A1 described above) to the owner B's device. Alternatively, the user identifier can be created during the session in order to ensure that it is unique within the group. Owner B's device 2 sends a group identifier to user A's device 12. Owner B's device 2 might also send the current roster of group members (for example, a list of user identifiers) to user A's device 12. All this information is stored in tables on the respective devices 2 and 12. User A is thereby joined to the group G. The group-join session may also be put off to a later date.

Finally, in step A16, the connection is closed. The group members may now communicate and exchange information by whatever means is defined by the group policy.

A different group policy from that suggested in steps A1 and A15 could also be used, which allows greater independence from the devices, greater flexibility, and greater security.

In the first embodiment, the verification identifier is sent out-of-band (using the communications channel 22) in one direction and in-band (using the secure connection) in the opposite direction. “Out-of-band” in this context means using a different communications channel to the secure connection (“in-band” channel) over which the secure transaction is to be carried out. Therefore, in an embodiment of the present invention the verification identifier is sent over two different channels, one of which is the secure connection, and verified before allowing the secure transaction to take place over the secure connection.

The out-of-band channel need not be secure in a technical sense, since there need not be any encryption or other security technology associated with it. It can be secure in a human sense, with the level of security being trusted by both users. The security can be quite low; for example a phone call could have an eavesdropper, but this level of security might be enough for the users and the group formation policy. It preferably allows the users to authenticate each other, although not in a technical sense, for example by recognition of each other's voices, although this is not essential. Other examples of the out-of-band communications channel include physical contact of some sort between the users (exchanging a physical message); direct voice communication between the users; transfer of a device-readable storage device between the users; email; and Short Message Service. The users could also use a secure connection between their devices as the out-of-band channel if they had already set up such a channel in a previous secure transaction.

In the first embodiment, the device identifier is sent out-of-band in the same direction as the out-of-band verification identifier. In general, for other embodiments, whichever device will initiate the secure connection should learn the device identifier of the other device. It should be understood that communication of the device identifier need not be by way of the same channel as communication of the reference identifier, nor need it take place concurrently with communication of the reference identifier. An out-of-band channel of lesser or greater security, but of similar type, may be used to communicate the device identifier.

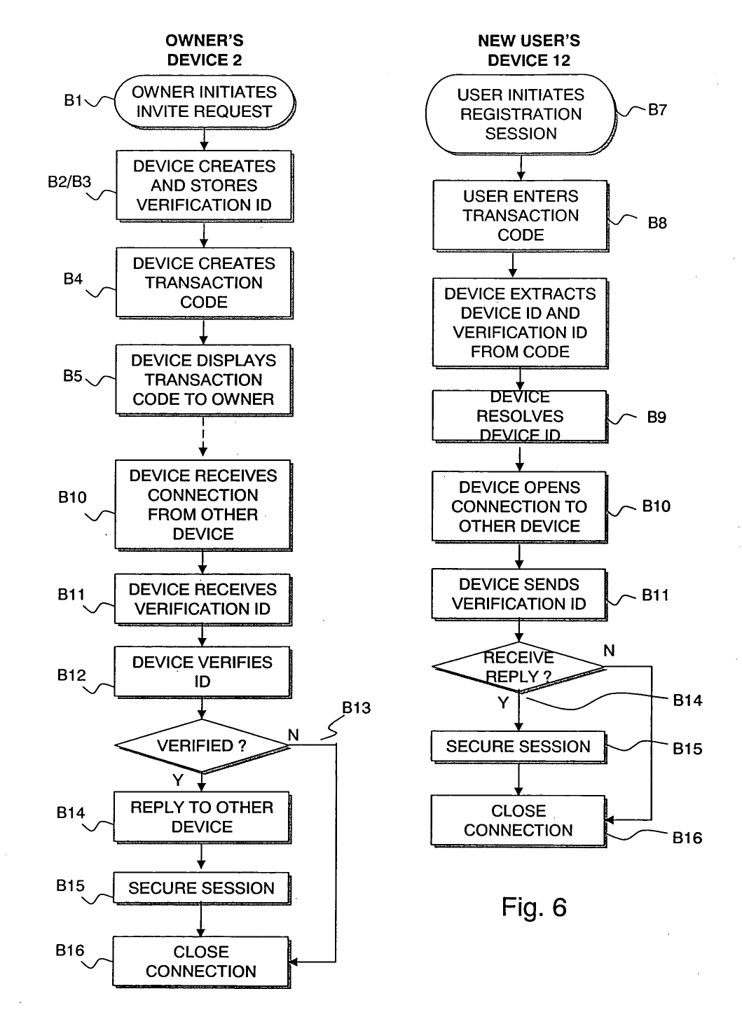

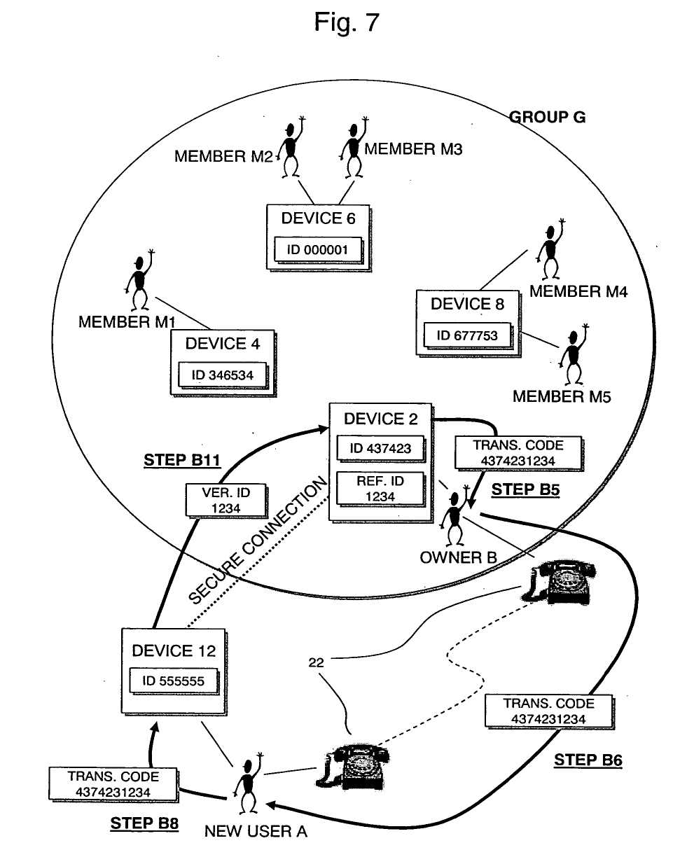

The second embodiment will now be described with reference to FIGS. 5 to 7. The second embodiment is similar to the first embodiment, differing principally in that it is the group owner B who initiates the group registration or join procedure by inviting the new user A to join his group G. FIG. 5 is a message exchange diagram showing the sequence of messages that pass between new user A, owner B, and their respective devices 12 and 2. FIG. 6 is a flowchart providing an alternative view of the procedures shown in FIG. 5, showing the flow of processing specifically for the new user's device 12 and the owner's device 2. FIG. 7 is a schematic diagram illustrating the various parties and devices and how they interact. Like reference numerals refer to like parts or method steps.

Because the first and second embodiments are very similar, it is unnecessary to describe the procedure for the second embodiment in detail, sufficing to provide a brief summary of the steps shown in FIGS. 5 to 7. The correspondence between the first and second embodiments will be readily apparent to the skilled person, with similar reference numerals (for example A1/B1 and 30A/30B) indicating method steps or parts that correspond closely.
B1. Owner B initiates an invite request on owner B's device 2.
B2. Owner B's device 2 creates a verification identifier.
B3. Owner B's device 2 stores the verification identifier in the device 2 as a reference identifier for later use.
B4. Owner B's device 2 creates a transaction code consisting of owner B's device identifier and the verification identifier.
B5. Owner B's device 2 communicates to owner B the transaction code.
B6. Owner B communicates the transaction code to the new user A by out-of-band channel 22.
B7. User A initiates a registration session on user A's device 12.
B8. User A enters the received transaction code on user A's device 12.
B9. User A's device 12 resolves the device identifier in the transaction code to the address of owner B's device 2.
B10. User A's device 12 opens a secure connection (by means of the trusted device network) to owner B's device 2.
B11. User A's device 12 sends the verification identifier to owner B's device 2.
B12. Owner B's device 2 verifies the verification identifier against stored reference identifiers.
B13. If not verified, owner B's device 2 closes the connection.
B14. If verified, owner B's device 2 deletes the reference identifier from the device 2 and accepts the registration by replying to user A's device 12.
B15. User A's device and owner B's device perform a secure transaction over the secure connection to join user A to owner B's group according to the group formation policy.
B16. The secure connection is closed.

In the second embodiment, like the first embodiment, the verification identifier is sent out-of-band (using the communications channel 22) in one direction and in-band (using the secure connection) in the opposite direction. Also like the first embodiment, the device identifier is sent out-of-band in the same direction as the out-of-band verification identifier.

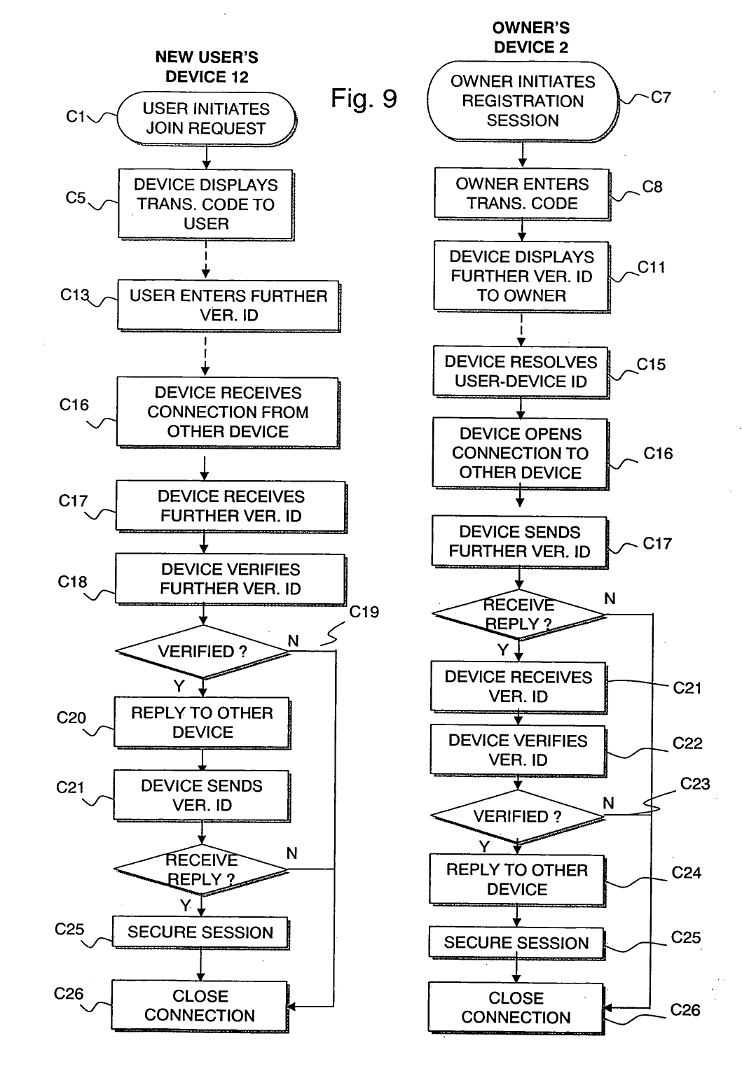

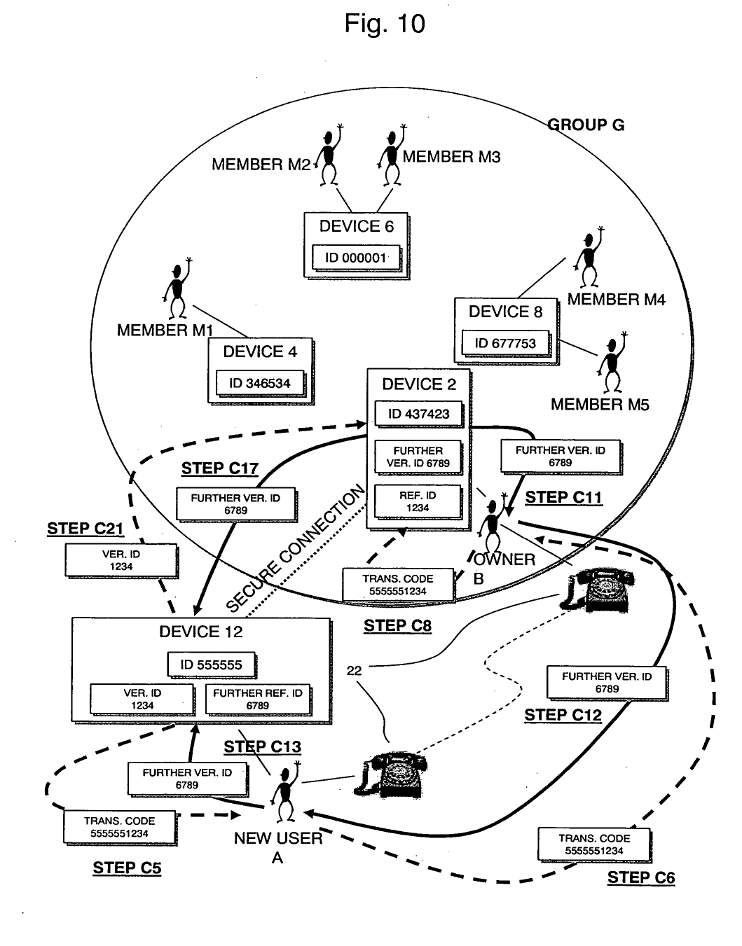

The third embodiment will now be described with reference to FIGS. 8 to 10. In the third embodiment, the new user A initiates the group registration or join procedure as for the first embodiment. FIG. 8 is a message exchange diagram showing the sequence of messages that pass between new user A, owner B, and their respective devices 12 and 2. FIG. 9 is a flowchart providing an alternative view of the procedures shown in FIG. 8, showing the flow of processing specifically for the new user's device 12 and the owner's device 2. FIG. 10 is a schematic diagram illustrating the various parties and devices and how they interact. Like reference numerals refer to like parts or method steps.

The third embodiment has many similarities with the first embodiment, and accordingly it is unnecessary to describe the procedure for the third embodiment in detail, sufficing to provide a brief summary of the steps shown in FIGS. 8 to 10 as follows. The principal differences and key similarities between the first and third embodiments will be described thereafter.
C1. User A initiates a join request on user A's device 12.
C2. User A's device 12 creates a verification identifier “1234”.
C3. User A's device 12 stores the verification identifier in the device 12 for later use.
C4. User A's device 12 creates a transaction code “5555551234” consisting of user A's device identifier and the verification identifier.
C5. User A's device 12 communicates or indicates the transaction code “5555551234” to user A using portion 20C (for example, a display).
C6. User A communicates the transaction code “5555551234” to owner B by out-of-band channel 22.
C7. Owner B initiates a registration session on owner B's device 2.
C8. Owner B enters the received transaction code “5555551234” on owner B's device 2 using portion 24C (for example, a keypad).
C9. Owner B's device 2 stores the verification ID “1234” extracted from the transaction code for use as a reference identifier.
C10. Owner B's device 2 creates a further verification identifier “6789” and stores it for later use.
C11. Owner B's device 2 communicates or indicates the further verification identifier “6789” to owner B using portion 21C (for example, a display).
C12. Owner B communicates the further verification identifier “6789” to user A by out-of-band channel 22.
C13. User A enters the further verification identifier “6789” on user A's device 12 using portion 25C (for example, a keypad).
C14. The further verification identifier “6789” is stored in device 12 as a further reference identifier for later use.
C15. Owner B's device 2 resolves user A's device 12 identifier to the address of user A's device 12.
C16. Owner B's device 2 opens a secure connection (by means of the trusted device network) to user A's device 12, using portions 26C and 28C.
C17. Owner B's device 2 sends the further verification identifier “6789” to user A's device over the secure connection, using portions 30C and 32C.
C18. User A's device 12 verifies the further verification identifier against previously-stored further reference identifier (in step C14) using portion 34C.
C19. If not verified, user A's device 12 closes the connection.
C20. If verified, user A's device 12 deletes the further reference identifier from the device 12 and accepts the registration by replying to owner B's device 2.
C21. User A's device 12 sends the verification identifier “1234” to owner B's device 2 over the secure connection.
C22. Owner B's device 2 uses portion 35C to verify the verification identifier against previously-stored reference identifier (in step C9).
C23. If not verified, the connection is closed.
C24. If verified, owner B's device 2 deletes the reference identifier from the device 2 and accepts the registration by replying to user A's device 12.
C25. User A's device 12 and owner B's device 2 perform a secure transaction over the secure connection in order to join user A to owner B's group according to the group formation policy.
C26. The secure connection is closed.

The third embodiment, unlike the first and second embodiments, requires two verifications to be carried out (in steps C22 and C18). The first verification relies on an out-of-band communication of a verification identifier in step C6 (as part of the transaction code created in step C4) coupled with an in-band communication in the same direction of the same verification identifier in step C21. The second or further verification relies on an out-of-band communication of a further verification identifier in step C12 (created in step C10) coupled with an in-band communication in the same direction of the same further verification identifier in step C17.

Thus, in the third embodiment the verification identifier and further verification identifier are sent out-of-band (using the communications channel 22) and in-band (using the secure connection) in the same direction, unlike in the first and second embodiments. The device identifier is sent out-of-band in the same direction as the first out-of-band verification identifier.

It is not essential that two such verifications are provided as in the third embodiment, although this provides extra security. One or other of the verifications could be provided on its own. It is also possible to couple a same-direction type of verification such (as described in the third embodiment) with an opposite-direction type of verification (as described in the first or second embodiments), or any other such combination of one or more verifications.

As mentioned above, in an embodiment of the present invention the transaction code can be exchanged by an out-of-band channel (i.e. a channel other than the channel over which the secure transaction is to take place) that both of the users trust. The simplest and most convenient channel is a voice phone call, which provides easy authentication. However, any other channel is permitted, including, but not limited to, physical contact, a removable storage device (disk, memory card, etc.), email, mail, SMS (Short Message Service), another secure group, or any other message delivery system.

The transaction code can be formed by any means from the unique device identifier and the verification identifier. One way is to append one to the other. Another way is to use a reversible function of the two identifiers (so that the recipient can decode it). Other methods will be readily apparent to the skilled person. It will also be appreciated that use of a transaction code comprising verification identifier and device identifier is not essential and that these two items of information can be communicated separately and not necessarily simultaneously.

The verification identifier and transaction code can be any string of characters or bits that can be communicated over the out-of-band channel, preferably a short string of decimal digits. Although the verification identifier was described above as being a randomly-generated number, this is not essential. For example, it could also be chosen by the device user.

Preferably the verification identifier should uniquely identify the transaction, or at least uniquely within a certain spatial or time domain, so that if multiple transactions are initiated then the verification identifier for one transaction will not be confused for the verification identifier for another transaction. Such a verification identifier can be used for the purpose of (a) identifying and (b) securing the transaction. In the case of randomly-generated verification identifiers, if the number is chosen randomly from a sufficiently large pool of numbers, this would suffice to provide an acceptable level of uniqueness, or else it could be arranged that a number is not used more than once at any one time.

However, if it is known that multiple transactions will not occur, or that the verification identifier and corresponding stored reference identifier will be discarded before another transaction is initiated, then a unique verification identifier is not required. For example, in the third embodiment where two verifications are required (one in each direction), the basic and further verification identifiers could be the respective device identifiers of the two devices, effectively forming an overall verification identifier comprising both device identifiers. This would uniquely identify the transaction as being between the two devices, which may be sufficient, although it would not differentiate between multiple concurrent transactions between the same two devices. Likewise it may be sufficient to use the device identifier of one of the devices only as the reference identifier, which would be sufficient if multiple transactions involving that device were not initiated concurrently. Therefore use of a verification identifier in a method embodying the present invention at least provides a method of securing the transaction, if not identifying it.

As described above, the verification identifier and/or associated reference identifier can be made to expire after a set period of time. After a predetermined number of uses, for example after a single use, the verification identifier and/or associated reference identifier can also be discarded or otherwise marked so that it cannot be used again.

A method embodying the present invention is simple and convenient for the user because the only action required of the user is a phone call to another user to exchange a short string. No infrastructure other than the trusted device network is required, and the user does not need a pre-established electronic identity. A system embodying the present invention is secure because (a) it relies on a trusted out-of-band communication in which the two users have agreed on the level of trust required, and (b) because all ensuing transactions are performed over the trusted device network.

Several attacks are possible. In one attack, a third party could listen in on the out-of-band communication, get the transaction code, and enter it on his own device. Although unlikely, if it occurred, the third party could either cause the user A to initiate a secure transaction with him (first embodiment), to himself initiate a secure transaction with owner B (second embodiment), or do nothing (third embodiment). In the context of joining a group, the issue with second embodiment is the most serious, so the first and third embodiments are preferred in practice.

In a second type of attack, a third party masquerades as the owner and attempts to initiate a secure transaction with a new user by sending a fake verification identifier over a secure connection to the new user's device (without having previously performed an out-of-band communication with the new user). This attack is unlikely to be successful, especially if the verification identifiers are randomly chosen from a large enough pool. If the same device continues to send connection requests with fake identifiers, it can be put on a black list by the receiving device.

In a third attack, a third party with a device outside of the trusted device network (i.e., in the public network) attempts to connect to a device within the trusted network, or otherwise interfere with communications. Such an attack would be unsuccessful, since a secure network is assumed.

As indicated above, an embodiment of the present invention is not limited to particular group formation policies, the level of security provided, the topology of the group network, the methods of transferring information in the group, or any other group-related activity related to a group policy. For example, a group could use a shared key to encrypt all group messages and a broadcast technique to propagate messages to all group members. Or group members could encrypt and send messages in a pair-wise fashion. Or group members might opt not to use security on some or all messages. Other schemes would be readily apparent to the person skilled in the art.

An embodiment of the present invention can be used by a group of people, using suitable devices, to set up a secure and private network between themselves for any purpose. The set up is straightforward and convenient and does not require the people to have any pre-established electronic identities.

For example, a family could set up a VPN (Virtual Private Network) between their various homes. In this scenario, the system could be integrated into a television, set-top box, DVD player/recorder, personal multimedia player, digital video recorder (DVR or PVR), or any other home appliance or consumer electronic device. The family could establish the VPN, and then communicate by text, voice, or video with each other with complete security. Or they could securely share multimedia such as photographs, home videos, stories, and so on.

In other applications, users of the mobile Internet (on mobile devices such as phones, PDAs, and laptops) could easily perform secure transactions or set up secure groups for communication and sharing.

In business applications, business users could easily set up secure groups for collaboration. The system could be integrated into any business-related devices including PCs, laptops, PDAs, projectors, printers, or other I/O devices.

As well as enabling of maintaining a group as described above, a method embodying the present invention can also be used for configuring a trusted network in a secure way, for example adding or modifying a user's rights to use or access network resources such as databases, memory, storage, devices, and processors, or setting up of a payment mechanism, or setting up of a service such as a newsfeed, download service, or communication service.

It will be appreciated that any or all of the above functions of the user device 12 and the owner device 2 can be carried out by hardware or software, or a combination thereof. An operating program for this purpose can be stored on a device-readable medium, or it could, for example, be embodied in a signal such as a downloadable data signal provided from an Internet website. The appended claims are to be interpreted as covering an operating program by itself, or as a record on a carrier, or as a signal, or in any other form.

What is claimed is:

1. A method of enabling respective users of first and second devices of a trusted network to perform a secure transaction between them, comprising:
establishing a communications channel between the users;
communicating a verification identifier for the transaction between the users using the communications channel;
storing the verification identifier at the first device as a reference identifier for the transaction;
opening a secure connection between the two devices over the trusted network, the secure connection being different to the communications channel between the users;
sending the verification identifier from the second device to the first device over the secure connection;
comparing the verification identifier received over the secure connection with the reference identifier at the first device; and
performing the secure transaction over the secure connection in dependence upon the comparison.

2. A method as claimed in claim 1, comprising performing the secure transaction only if the comparison indicates a match between the verification and reference identifiers.

3. A method as claimed in claim 1, comprising closing the secure connection if the comparison does not indicate a match between the verification and reference identifiers.

4. A method as claimed in claim 1, further comprising:
communicating a first device identifier, identifying the first device in the network, from the first user to the second user; and
using the first device identifier at the second device to open the secure connection.

5. A method as claimed in claim 4, wherein the first device identifier is communicated using the communications channel between the users.

6. A method as claimed in claim 1, wherein the verification identifier is communicated from the first user to the second user using the communications channel, and further comprising inputting the verification identifier into the second device for use in the sending step.

7. A method as claimed in claim 6, further comprising generating the verification identifier at the first device.

8. A method as claimed in claim 7, comprising generating a random number for use as the verification identifier.

9. A method as claimed in claim 6, further comprising:
communicating a first device identifier, identifying the first device in the network, from the first user to the second user; and
using the first device identifier at the second device to open the secure connection;
and comprising communicating a single transaction code from the first user to the second user comprising the first device identifier and the verification identifier.

10. A method as claimed in claim 9, wherein the transaction code is formed by appending the first device identifier to the verification identifier.

11. A method as claimed in claim 6, further comprising:
communicating a first device identifier, identifying the first device in the network, from the first user to the second user; and
using the first device identifier at the second device to open the secure connection;
wherein the first device identifier is used as the verification identifier.

12. A method as claimed in claim 1, wherein the verification identifier is communicated from the second user to the first user using the communications channel, and further comprising inputting the verification identifier into the first device for use in the storing step.

13. A method as claimed in claim 12, further comprising generating the verification identifier at the second device.

14. A method as claimed in claim 13, comprising generating a random number for use as the verification identifier.

15. A method as claimed in claim 12, wherein a second device identifier, identifying the second device in the network, is used as the verification identifier.

16. A method as claimed in claim 1, wherein the communications channel is a communications channel that is trusted by the first and second users.

17. A method as claimed in claim 1, wherein the communications channel is one or more of: a telephone call between the users; physical contact between the users; direct voice communication between the users; transfer of a device-readable storage device between the users; email; and Short Message Service.

18. A method as claimed in claim 1, further comprising revoking the reference identifier after a predetermined period of time.

19. A method as claimed in claim 1, further comprising revoking the reference identifier after first use.

20. A method as claimed in claim 1, wherein at least one of the first and second devices is a multi-user device.

21. A method as claimed in claim 1, wherein at least one of the identifiers comprises one or more of: a number; a string; a name; an IP address; and a domain name.

22. A method as claimed in claim 1, further comprising indicating the verification identifier for use in the communicating step to one of the users using that user's device.

23. A method as claimed in claim 22, comprising displaying the verification identifier on a screen of the user's device.

24. A method as claimed in claim 1, further comprising inputting the verification identifier received by one of the users in the communicating step into that user's device.

25. A method as claimed in claim 24, comprising inputting the verification identifier using a keypad of the user's device.

26. A method as claimed in claim 1, wherein the verification identifier uniquely identifies the transaction.

27. A method as claimed in claim 1, wherein the network is a peer-to-peer network of devices.

28. A method as claimed in claim 1, further comprising:
communicating a further verification identifier for the transaction between the users using the same or a different such communications channel;
storing the further verification identifier at the second device as a further reference identifier for the transaction;
sending the further verification identifier from the first device to the second device over the secure connection;
comparing the further verification identifier received over the secure connection with the further reference identifier at the second device; and
performing the secure transaction over the secure connection in dependence upon the comparison.

29. A method of maintaining a group, comprising a plurality of members, using a method as claimed in claim 1, wherein the step of performing a secure transaction relates to the addition or removal of one of the first and second users as a member of the group, the other of the first and second users being a designated coordinator for the group.

30. A method of configuring a trusted network, comprising a method as claimed in claim 1.

31. A method for use by a first device of a trusted network for enabling a user of the first device to perform a secure transaction with a user of a second device of the trusted network, comprising:
indicating a verification identifier for the transaction to the user of the first device for communication to the user of the second device using a communications channel established between the users, or inputting a verification identifier for the transaction communicated to the user of the first device from the user of the second device using a communications channel established between the users;
storing the verification identifier as a reference identifier for the transaction;
opening a secure connection between the two devices over the trusted network, the secure connection being different to the communications channel between the users;
receiving the verification identifier from the second device over the secure connection;
comparing the verification identifier received over the secure connection with the reference identifier; and
performing the secure transaction over the secure connection in dependence upon the comparison.

32. A method for use by a second device of a trusted network for enabling a user of the second device to perform a secure transaction with a user of a first device of the trusted network, comprising:
indicating a verification identifier for the transaction to the user of the second device for communication to the user of the first device using a communications channel established between the users, or inputting a verification identifier for the transaction communicated to the user of the second device from the user of the first device using a communications channel established between the users, the verification identifier being stored at the first device as a reference identifier for the transaction;
opening a secure connection between the two devices over the trusted network, the secure connection being different to the communications channel between the users;
sending the verification identifier to the first device over the secure connection for use by the first device in comparing with the reference identifier; and
performing the secure transaction over the secure connection in dependence upon the comparison.

33. A system for enabling respective users of first and second devices of a trusted network to perform a secure transaction between them, comprising:
means for establishing a communications channel between the users;
means for communicating a verification identifier for the transaction between the users using the communications channel;
means for storing the verification identifier at the first device as a reference identifier for the transaction;
means for opening a secure connection between the two devices over the trusted network, the secure connection being different to the communications channel between the users;
means for sending the verification identifier from the second device to the first device over the secure connection;
means for comparing the verification identifier received over the secure connection with the reference identifier at the first device; and
means for performing the secure transaction over the secure connection in dependence upon the comparison.

34. A device for use in a trusted network for enabling a user of the device to perform a secure transaction with a user of another device of the trusted network, comprising:
means for indicating a verification identifier for the transaction to the user of the device for communication to the user of the other device using a communications channel established between the users, or inputting a verification identifier for the transaction communicated to the user of the device from the user of the other device using a communications channel established between the users;
means for storing the verification identifier as a reference identifier for the transaction;
means for opening a secure connection between the two devices over the trusted network, the secure connection being different to the communications channel between the users;
means for receiving the verification identifier from the other device over the secure connection;
means for comparing the verification identifier received over the secure connection with the reference identifier; and
means for performing the secure transaction over the secure connection in dependence upon the comparison.

35. A device for use in a trusted network for enabling a user of the device to perform a secure transaction with a user of another device of the trusted network, comprising:
means for indicating a verification identifier for the transaction to the user of the device for communication to the user of the other device using a communications channel established between the users, or inputting a verification identifier for the transaction communicated to the user of the device from the user of the other device using a communications channel established between the users, the verification identifier being stored at the other device as a reference identifier for the transaction;
means for opening a secure connection between the two devices over the trusted network, the secure connection being different to the communications channel between the users;
means for sending the verification identifier to the other device over the secure connection for use by the other device in comparing with the reference identifier; and
means for performing the secure transaction over the secure connection in dependence upon the comparison.

36. An operating program which, when loaded into a device, causes the device to become a device as claimed in claim 34.

37. An operating program as claimed in claim 36, carried on a carrier medium such as a transmission medium or a storage medium.

38. An operating program which, when loaded into a device, causes the device to become a device as claimed in claim 35.

39. An operating program as claimed in claim 38, carried on a carrier medium such as a transmission medium or a storage medium.

40. An operating program which, when run on a device, causes the device to carry out a method as claimed in claim 31.

41. An operating program as claimed in claim 40, carried on a carrier medium such as a transmission medium or a storage medium.

42. An operating program which, when run on a device, causes the device to carry out a method as claimed in claim 32.

43. An operating program as claimed in claim 42, carried on a carrier medium such as a transmission medium or a storage medium.
